(19) United States
(12) Patent Application Publication
(10) Pub. No.: US 2009/0316780 A1
(43) Pub. Date: Dec. 24, 2009

(54) Video coding method with non-compressed mode and device implementing the method

(76) Inventors: Lionel Tchernatinsky, Rennes (FR); Karine Lorvellec, La Meziere (FR); Denis Mailleux, Vitre (FR)

Correspondence Address: Robert D. Shedd, Patent Operations;THOMSON Licensing LLC, P.O. Box 5312, Princeton, NJ, 08543-5312, US

(21) Appl. No.: 12/456,799

(22) Filed: Jun. 23, 2009

(30) Foreign Application Priority Data
Jun. 23, 2008 (FR) 0854135

(51) Int. Cl. H04N 7/26

(52) U.S. Cl. 375/240.02; 375/240.24; 375/E07.126

(57) ABSTRACT

The present invention relates to a method of video coding comprising a mechanism enabling activation or deactivation of the compression of macroblocks of the video stream to be coded according to the efficiency of the compression and functioning in at least two modes, a first normal coding mode and a second non-compressed coding mode, said method being wherein it comprises normal coding mode, the macroblock being processed is compressed by a coding loop then by an entropic coder, said compression being considered efficient if the size occupied by the compressed macroblock is noticeably less than the size occupied by the macroblock without compression, in the case where the compression of the macroblock being processed is not efficient, the non-compressed mode is activated (6), said non-compressed mode being characterized in that the samples of the video source corresponding to a macroblock being processed are transmitted without compression at the output of the coder, the non-compressed mode being maintained after having been activated as long as the functional elements of the coding loop have not returned to a stable state.

Another purpose of the invention is a video coding device implementing the method.

### FIELD OF THE INVENTION

The invention relates to a method and a video coding device and applies particularly to the domains of video transmission, analysis, decoding and transcoding.

### DESCRIPTION OF THE PRIOR ART

A video sequence comprises by its nature a high statistical redundancy both in the temporal and spatial domains. The desire to always use more efficiently the transmission media bandwidths on which these sequences transit and the objective of reducing the cost of their storage posed the question very early on of video compression. The standard video compression techniques can generally be divided into two steps. The first aims to reduce the spatial redundancy and to do this to compress a fixed image. The image is first divided into blocks of pixels (of 4×4 or 8×8 according to, for example, the MPEG-1/2/4 standards), a passage into the frequency domain followed by a quantization enabling the approximation or deletion of high frequencies to which the eye is less sensitive, and finally the quantized data are coded in an entropic manner. The purpose of the second step is to reduce the temporal redundancy. This technique enables an image to be predicted from one or more other reference images previously decoded within the same sequence (motion prediction). This technique consists in searching in these reference images for the block that best corresponds to that to be predicted, and only a motion estimation vector is retained corresponding to the displacement of the block between the two images as well as a residual error enabling the visual yield to be refined.

A standard video encoder processing a video signal after slicing of the images into macroblocks is comprised specifically of the following two functional elements:
a coding loop realizing the passage into the frequency domain, the quantization, the motion compensation the intra prediction and the loop filtering,
an entropic coder realizing a compression without loss of signal after signal quantization, for example, with a Huffman coding or an arithmetic coding.

A macroblock is compressed by first being processed by the coding loop followed by the entropic coder. In a standard system, these two steps can be considered as being independent.

The compression techniques using motion prediction and intra prediction prove to be very efficient and practical. However, for some images of a video stream and/or when the quantization uses a very weak step, the compression provides inconclusive results. Notably it is possible to have at the output of a video coder a number of bits after compression greater than the number of bits of the source. In this case it is more advantageous the transmit the stream in non-compressed mode, that is to say transmit at the output of the video encoder the samples of the source video corresponding to the macroblock currently being processed. As an example, the H.264 standard defines a non-compressed mode called I_PCM mode. When this mode is activated, the source samples, that is, the luminance and chrominance components representing the image pixels are transmitted directly to the functional block carrying out the entropic coding to be formatted there without any compression being applied. There are two use cases of the I_PCM coding mode in the H.264 standard:
use in standard coding mode: The I_PCM mode can be used by an encoder in the same way as all the other proposed modes, it is noted that the bitrate generated per macroblock is then constant,
use in fallback mode: a maximum size is imposed on the stream of bits generated for the coding of a macroblock. This signifies that if the number of bits corresponding to a macroblock following compression exceeds a limit value, the I_PCM coding mode is used and the samples of the source video are transmitted directly.

The limit value imposed by the standard for use in fallback mode is fixed at the value at which an encoder ceases to reduce the bitrate and where it becomes more interesting to transmit the source directly. For example, during 4:2:0 coding on 8 bits, a macroblock is represented on 3072 bits. The H.264 standard defines the maximum number of bits, or 3200 bits, beyond which use of the I_PCM coding mode is required. The number of bits required for coding a non-compressed macroblock corresponds to the bits required at the transmission of luminance and chrominance samples, or the 3072 bits previously cited as well as the bits required at the transmission of mode information (mb_type and mb_skip_flag, for example). The decision to use this coding mode as well as the implementation of the I_PCM mode, when the fallback mode is considered, is made at entropic coder level. This checks number of bits generated following the processing of each macroblock by the coding loop and entropic coding. If this number is greater than a limit of 3200 bits, the bits generated are withdrawn from the final bits stream, the coding contexts are restored, that is to say the entropic coder returns to the preceding state in which it was at the start of the macroblock, and the source samples are transmitted in the bits stream. When the I_PCM mode is selected by the entropic coder, a control signal called ‘I_PCM_control’ is activated and is propagated to functional blocks of the coding loop, that is to say to the prediction blocks (intra and inter), the reconstruction blocks and possibly to other blocks of the encoder according to the implementation choice.

The coding of a macroblock depends upon the coding of its neighbours. For example, in the case of the H.264 standard, there is a spatial dependence of the current macroblock with respect to the macroblock situated on its left and to the macroblock situated above it. Ideally, the coding of these macroblocks should be finished before being able to process the current macroblock.

In order to optimize the implementation of the encoder and avoid a purely sequential processing of macroblock after macroblock, it is usual to process the macroblocks in parallel. Due to the functional separation of the encoding loop and the entropic coder, the current macroblock can be processed before the processing of adjacent blocks is finished. For example, if the block on the left is currently undergoing entropic coding the processing operations of the encoding loop (transformation, quantization, etc.) can be applied in parallel to the current block. A “pipeline” type encoder architecture can thus be realized.

If the non-compressed mode is implemented in fallback mode, as the choice of activation or not of the mode is made at entropic coder level, it is not possible to foresee the manner in which the adjacent blocks will be coded before their processing by the entropic coder has finished It is necessary in this case to wait for the result of entropic coding and the processing operations of the encoding loop and the entropic coder can no longer be in parallel. When the coding mode of a macroblock is only known late as is the case when a non-compressed mode is selected by the entropic coder, numerous functional blocks can not begin the next macroblock processing operations before the arrival of this information. In fact, during a late change in the coding mode, the contextual information of a current macroblock becomes incoherent. When there are “pipelines” in the realization of the encoder, it is observed that the information of preceding macroblocks is also incoherent. One of the “pipelines” of the coding loop begins at prediction operator level then passes by the operators of transform, quantization, inverse quantization and inverse transform, reconstruction and intra prediction to return to the prediction operator level. Another “pipeline” begins at the quantization operator output and carries out all the entropic coding operations that comprise, among others, the operations of binarization, arithmetic coding and the choice of macroblock coding in compressed or non-compressed mode. The coding loop and the entropic coder can carry out their operations in parallel, the two pipelines do not therefore have the same depth and are not synchronized, the processing of the current macroblock by the coding loop cannot begin before the end of processing of the preceding macroblock, while the entropic coder can begin the processing of the current macroblock before finishing the processing of the preceding macroblock. When the entropic coder chooses the non-compressed mode, the account taken of this new coding mode by the “pipeline” of the coding loop provokes the appearance of incoherent data at the output of the coding loop. This incoherence results from for example the account taken, during the coding of the current macroblock following a non-compressed macroblock, of a macroblock reconstructed according to the coding loop that is different from the non-compressed macroblock present in the bits stream. The consequence is that distortions are introduced in the video sequence when the non-compressed mode is used. In other words, distortions are introduced when the internal state of the decoder is not coherent with respect to the internal state of the video coder.

In practice this dependence renders difficult the realization of an encoder on a parallel platform (multiprocessor, DSP, FPGA or ASIC) in the presence of non-compressed macroblocks. As an example, if it is required to process 1620 macroblocks per 40 millisecond period and a given implementation enables this temporal constraint to be satisfied by executing in parallel the operations of the encoding loop and the entropic coder, when the non-compressed mode is activated, the processing in parallel is rendered impossible and it becomes difficult to adhere to the 40 millisecond constraint.

In practice, in the case of H.264 encoders, the majority of implementations bypass the problem by not implementing the I_PCM coding mode. This is a statistically valid solution as the conditions for the appearance of the I_PCM coding are rare. The inconvenience is that it remains possible to generate an incorrect stream from the syntactic or semantic perspective. Said stream cannot in consequence be decoded.

Another solution to the problem is to memorize at the level of the functional blocks of the video encoder the state of the macroblocks already coded and make a total restoration into a preceding state when an I_PCM macroblock appears. This solution presents two major disadvantages:
each of the functional blocks must be able to store the volume of data necessary to the restoration (samples, coding mode and other attributes such as motion vectors),
the data stream is interrupted during restoration. This solution requires that the functional blocks must return to the coding of macroblocks that were already coded and therefore places macroblocks in standby.

### SUMMARY OF THE INVENTION

One purpose of the invention is notably to overcome the disadvantages described above.

To this end the purpose of the invention is a video coding method comprising a mechanism enabling the activation or deactivation of the compression of video stream macroblocks to be coded according to the efficiency of compression and operating in at least two modes, the first coding mode being normal and the second being non-compressed, said method being characterized in that:
in normal coding mode, the macroblock being processed is compressed by a coding loop then by an entropic coder, said compression being considered efficient if the size occupied by the compressed macroblock is noticeably less than the size occupied by the macroblock without compression,
in the case where the compression of the macroblock being processed is not efficient, the non-compressed mode is activated, said non-compressed mode being characterized by the fact that the samples of the source video corresponding to the macroblock being processed are transmitted without compression at the output of the coder, the non-compressed mode being maintained after having been activated as long as the functional elements of the coding loop have not returned to a stable state.

A variant of this method is characterized in that following activation of the non-compressed mode, the detection of the return of stability of the coding loop is indicated to the entropic coder via a control signal, said signal being positioned in an active state when the set of functional blocks of the coding loop affected by the activation of the non-compressed mode have returned to a stable state.

A variant of this method is characterized in that, following the activation of the non-compressed mode, the return to stability of the coding loop is deduced by the entropic coder via a parameter indicating the restoration time, the value of said parameter having to be determined in a way so that the elements of the coding loop have the time to return to a stable state during this period.

A variant of the method is characterized in that the video coder follows the specifications of the H.264 standard.

A variant of this method is characterized in that the compression efficiency is verified by comparing the number of bits after compression of the current macroblock with a threshold value.

A variant of the method is characterized in that following the activation of the non-compressed mode, the state of the entropic coder is restored, that is to say the entropic coder returns to the previous state in which it was found at the start of the processing of the macroblock for which the non-compressed mode was triggered.

Another purpose of the invention is a video coding device implementing the method and characterized in that it comprises at least:
a coding loop enabling the macroblocks to be compressed applying at least the steps of transform, quantization, intra prediction and motion compensation to the incoming signal,
an entropic coder realizing in normal coding mode a compression of the data stream at the output of the coding loop and comprising the means to verify the efficiency of the compression, the means to decide on the use of the non-compressed mode, the means to configure the coding loop of the device and the means to verify the stability of said loop.

### BRIEF DESCRIPTION OF THE DRAWINGS

Other characteristics and advantages of the invention will emerge with the help of the description that follows provided as a non-restrictive example, made with regard to the annexed drawings wherein:

FIG. 1 shows the method according to the invention introducing a forced non-compressed mode,

FIG. 2 presents an example of timing diagrams showing the sequence of operations executed by a device according to the invention,

FIG. 3 presents an example of the video compression device comprising the method according to the invention.

The invention has notably the advantage of enabling the execution in parallel of operations of the coding loop and of the entropic coder when the forced non-compressed mode is activated and so of reducing the operations execution time. In addition, the invention enables the constituent functional blocks of the coding loop of the video coder to return to a stable state before again taking up the compression of macroblocks an thus to avoid unwanted distortions in the video stream.

### DETAILED DESCRIPTION OF THE PREFERRED EMBODIMENTS

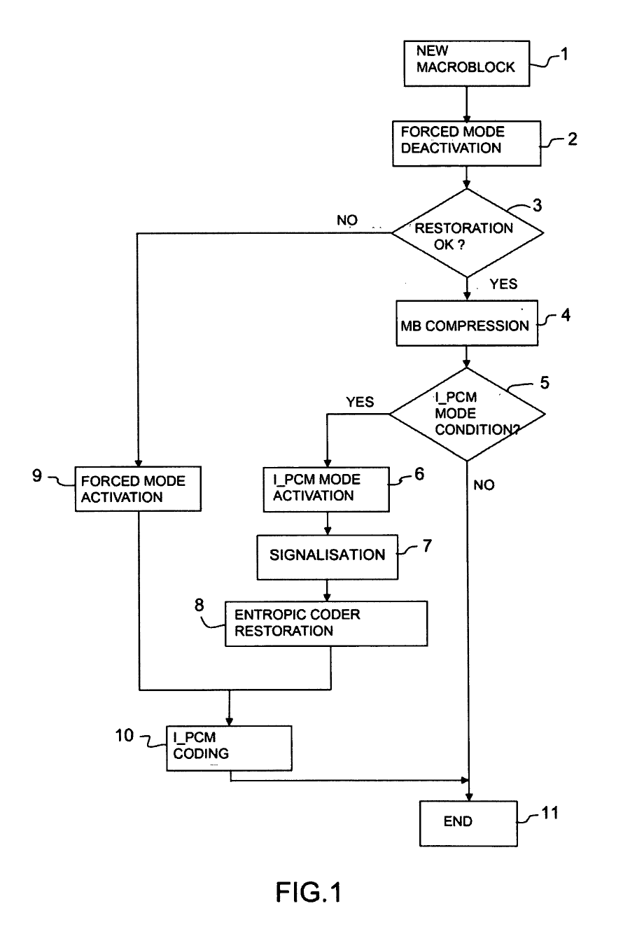

FIG. 1 shows with a diagram an example of implementation of the method according to the invention. The method according to the invention, as described hereafter, processes a compressed video stream macroblock by macroblock. A macroblock represents a part of an image of a video stream. This part of the image comprises a set of pixel blocks. As an example, a macroblock can represent 16×16 pixels of an image. The macroblock processed at a given instant by the method is called in the description the current macroblock or the macroblock being processed, the two expressions having the same meaning.

The method is composed of steps to be applied for each macroblock of the video stream to be compressed. The method enables, initially, to detect if the compression is efficient for the macroblock being processed. Secondly, if the compression is not considered as efficient, the signal samples of the macroblock being processed are transmitted without being compressed. The transmission of the macroblocks following is then forced in non-compressed mode so that the coding loop converges to a stable state and the compression of macroblocks can recommence without distortions being introduced artificially in the images of the video sequence to be transmitted. In other words, the functional blocks of the coding loop operate a context restoration, the context of a macroblock being composed of the set of saved data and that is used for the coding of the next macroblocks.

As shown previously, a video coder is typically constituted of a coding loop and an entropic coder. In the example of FIG. 1, the notations introduced take into account the terminology specific to the H.264 standard. Hence the non-compressed mode is designated as being the I_PCM mode. The method according to the invention can be considered outside of the scope of the H.264 standard. The method according to the invention is executed at the level of the entropic coder for each macroblock processed by the video coder.

The method is executed as soon as a new macroblock is detected 1 at the input of the entropic coder. The forced mode is deactivated by default 2 by positioning, for example, a Boolean variable referred to as ‘forced_I_PCM_mode’ to ‘0’. The stability of functional blocks impacted by the I_PCM mode is then verified 3. The functional blocks are considered as being in a stable or coherent state when they do not introduce distortion at the recommencement of the compression in normal mode.

If the state of the blocks is not stable, this means that the I_PCM mode was recently activated for one of the macroblocks previously processed and that the context restoration for the functional blocks of the coding loop is not terminated. In this case, the forced I_PCM mode is activated 9. The ‘forced_I_PCM_mode’ variable is positioned at ‘1’, the macroblock being processed is transmitted without compression 10 and the execution of the method terminates 11. The forced mode enables the functional blocks of the video coder to return to a stable state. This restoration phase consists in returning to a coherent state the data of the macroblocks. During this period, it is useless to resume the re-coding operations (prediction, transform, quantization, inverse transform, inverse quantization, reconstruction, etc.).

If the state of the functional blocks of the coding loop is stable, as is the case in normal mode, the macroblock being processed is compressed 4 by the entropic coder. The efficiency of the compression is then verified 5.

As already cited previously as an example, if the coder works in 4:2:0 format on 8 bits and if the macroblock after being compressed occupies more than 3200 bits, the use of I_PCM mode is activated. The ‘forced_I_PCM_mode’ is positioned at ‘1’ 6. The functional blocks of the coding loop of the video coder must then be configured as a consequence. To do this, a signalling is implemented 7. The bits generated after compression are then withdrawn from the bits stream and coding contexts of the entropic coder are restored 8, that is to say the entropic coder returns to the state in which it was at the start of the macroblock. The macroblock being processed is then transmitted without compression 10 and the execution of the method terminates 11.

If the compression of the macroblock being processed is efficient 5, the macroblock is transmitted compressed at the output of the coder and the execution of the method terminates 11.

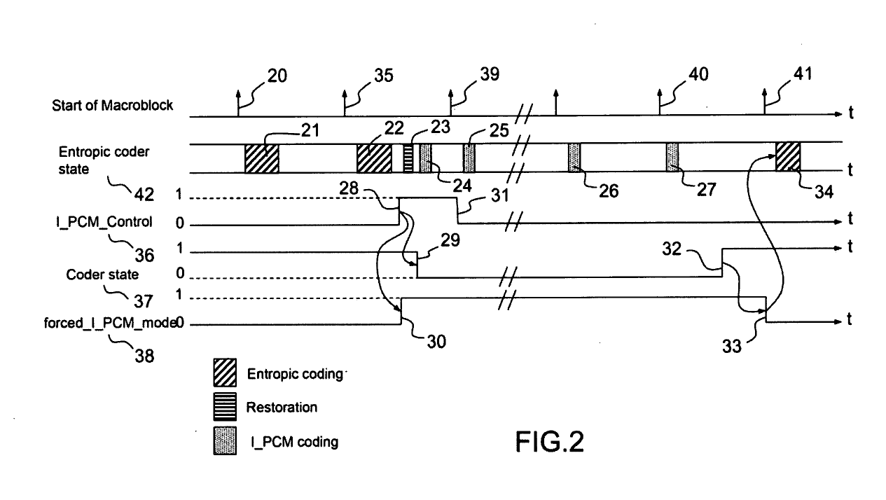

FIG. 2 presents an example of timing diagrams showing the sequence of operations executed by a device according to the invention. Said diagrams enable the state of the entropic coder 42 to be followed, and the state of the control signals used by the device, or the I_PCM_Control signal 36 indicating the activation of the I_PCM mode, the ‘coder_state’ signal 37 indicating if the video coder is in a stable state and the forced_I_PCM_mode signal 38 indicating the activation of the forced I_PCM mode. The figure shows that the non-compressed mode, or the I_PCM mode in the case of the H.264 standard, is processed by the method according to the invention as a computing exception comprising a restoration period following the occurrence of this exception. When the coefficients after quantization representing a macroblock at the output of the coding loop are available 20 at the input of the entropic coder, the entropic coder compresses the macroblock 21. If the compression is judged to be efficient, the compressed stream is presented at the output of the video coder. The operation is repeated for the next macroblock 35. The entropic coder compresses 22 the input stream. The method again verifies the efficiency of the compression. In the example of FIG. 2, the compression of the second macroblock is judged to be inefficient. It is decided to pass into I_PCM mode. To do this, an ‘I_PCM_Control’ signalling signal 36 is activated 28 in order to configure the functional blocks of the coding loop of the video coder. These are in general functional blocks of the coding loop for which the coding depends on the state of the neighbouring blocks (intra and inter predictions, reconstruction, entropic coding) and possibly other blocks according to the implementation choices.

The forced mode is then activated and to do this a ‘forced_I_PCM_mode’ binary signal enabling indication of the mode change takes the value ‘1’ 30. In this mode, the entropic coder places itself on standby for the end of restoration of the coding loop. During this waiting period, the I_PCM mode is systematically used for the entropic coding of macroblocks.

The compress stream generated 22 is removed from the output stream of the video coder, the state of the entropic coder is restored 23 to as it was before the coding of this macroblock 35. The state of the coding loop becomes unstable and the ‘coder_state’ signal passes from ‘1’ to ‘0’ as a consequence 29. The macroblock being processed is transmitted at the output of the video coder after I_PCM coding without having been compressed.

The processing of the next macroblock 39 takes place after verification of the stability of the coding loop, that is to say that the video coder is in standby for the restoration of the loop.

During the restoration the data transmitted to the entropic coder can be incoherent for at least two reasons:
the functional blocks have not yet taken account of the use of the I_PCM mode by the entropic coder,
the restoration can also provoke incoherencies in the coding pipeline.

These incoherencies have no incidence, as the entropic coder uses the I_PCM mode to mask them. In addition, the I_PCM mode is an intra mode unaffected by the context of neighbours contrary to other coding modes. At the end of the restoration operation of the coding loop, the data transmitted to the entropic coder are coherent again.

The ‘coder_state’ signal 37 is at ‘0’ which indicates that the condition of coding loop stability is not fulfilled. The forced I_PCM mode is therefore maintained and the ‘forced_I_PCM_mode’ signal 38 remains at ‘1’. The ‘I_PCM_Control’ signal 36 returns to ‘0’31.

As long as the state of the coding loop remains unstable the restoration phase is not terminated, the ‘coder_state’ signal 37 remains at ‘0’, the forced I_PCM mode remains activated and as a consequence the ‘forced_I_PCM_mode’ signal 38 remains at ‘1’. In this mode, the macroblocks are transmitted without being compressed 25, 26, 27. After a certain period, the functional blocks constituting the coding loop return to a stable state and the ‘coder_state’ signal 37 takes the value ‘1’ 32. For the next macroblock to be processed 41, the stability state of the coding loop is detected and the forced I_PCM mode is deactivated. The ‘forced_I_PCM_mode’ signal then retakes the value ‘0’ 33 and the current macroblock is compressed in the normal way 34 by the entropic coder.

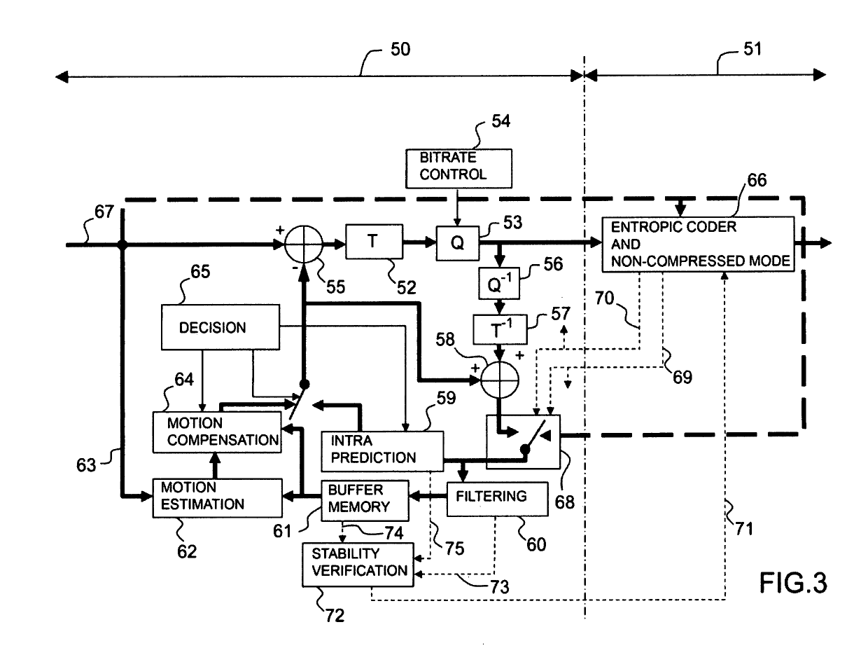

FIG. 3 shows an example of the video coding device implementing the method according to the invention. This is constituted of two main functional elements. The first is the coding loop 50 and the second is the entropic coder 51.

The principle of the coding loop 50 is well known to those skilled in the art. A block 52 takes at input samples of the source after compensation 55, said block realizing a transform enabling passage from the temporal to the frequency domain. This transform can be for example an entire transform as specified in the H.264 standard. The result of the transform is then quantified 53, this operation destroys the data faintly visible to the human eye and reduces the amount of data to be transmitted. This operation is configured 54 according to, for example, the target bitrate to be guaranteed at the output of the video coder. The signal after quantization 53 is reconstructed using a local decoder realizing the inverse quantization operations 56, the inverse transform operations 57 and the reconstruction operations 58. When the non-compressed mode is not used, the macroblock after reconstruction is used by a set of functional blocks realizing the intra prediction 59 and the loop filter 60. The reconstructed blocks are memorized by the frame buffer 31 in order to carry out the motion estimation 62 between the signal at the video coder input 63 and said memorized blocks 61. The result of the motion estimation 62, typically a motion estimation vector, is itself used for the motion compensation 64 for the purpose of creating a prediction. A decision functional block 65 enables the intra prediction 59 and/or the motion compensation 64 to be configured and activated.

The second part of the video coder 51 is composed notably of a functional block carrying out the entropic coding 66. In addition, this functional block 66 comprises the decision means enabling the triggering of the non-compressed mode and to force it as described in the examples of FIGS. 1 and 2. For example, when the coding block 66 decides to activate the non-compressed mode, the ‘I_PCM_control’ 69 and the ‘forced_I_PCM_mode’ 70 signals as previously introduced are used to set parameters for the coding loop 50 and particularly the choice of input 68 of the coding loop. The choice is made between the source signal 67 and the signal resulting from the reconstruction 58. In fact, when the non-compressed mode is used, the source signal 67 is used directly by the blocks implicated in the motion compensation and intra prediction 59, 60, 61, 62, 64 instead of the signal resulting from the reconstruction 58.

Once the non-compressed mode is activated following a decision of the entropic coder 66, the coder passes into forced mode until the coding loop 50 has returned to a stable state. This state of stability can be indicated to the entropic coder 66 using for example a ‘coder_state’ signal 71 as introduced previously. This signal 71 is generated for example using a functional block 72 of the coding loop 50, said functional block taking at input the signals 73, 74, 75 informing on the stability of each of the blocks of the coding loop 50. In the example of FIG. 2, the signals of stability 73, 74, 75 are generated by filtering blocks 62, buffer memory 61 and filtering 60, but other configurations are possible according to the implementation chosen. For example, after activation of the I_PCM mode, each of the blocks increments a temporal counter and compares it to a temporal value that is specific to it and that, when said value is attained, ensures that said block is returned in a stable state. This return to stability is then indicated to the stability verification functional block 72.

The stability verification functional block 72 decides on the overall stability of the system when the set of input signals 73, 74, 75 indicate that the coding loop, in its entirety, has returned to a stable state. In this case, the coherence between the internal state of the decoder and the internal state of the coder is guaranteed. A possible alternative is to set a temporal period value and consider that after activation of the non-compressed mode, the coding loop has returned to a stable state at the end of this period.

1- Video coding method comprising a mechanism enabling the activation or deactivation of the compression of video stream macroblocks to be coded according to the efficiency of compression and operating in at least two modes, the first coding mode being normal and the second mode being non-compressed, wherein:
in normal coding mode, the macroblock being processed is compressed by a coding loop then by an entropic coder, said compression being considered efficient if the size occupied by the compressed macroblock is noticeably less than the size occupied by the macroblock without compression,
in the case where the compression of the macroblock being processed is not efficient, the non-compressed mode is activated, said non-compressed mode being characterized by the fact that the samples of the source video corresponding to the macroblock being processed are transmitted without compression at the output of the coder, the non-compressed mode being maintained after having been activated as long as the functional elements of the coding loop have not returned to a stable state.

2- Method according to claim 1 wherein, further to activation of the non-compressed mode, the detection of the return to stability of the coding loop is indicated to the entropic coder via a control signal, said signal being positioned in an active state when the set of functional blocks of the coding loop affected by the activation of the non-compressed mode have returned to a stable state.

3- Method according to claim 1 wherein, further to the activation of the non-compressed mode, the return to stability of the coding loop is deduced by the entropic coder via a parameter indicating the restoration time, the value of said parameter having to be determined in a way so that the elements of the coding loop have the time to return to a stable state during this period.

4- Method according to claim 1 wherein the video coding follows the specifications of the H.264 standard.

5- Method according to claim 1 wherein the compression efficiency is verified by comparing the number of bits after compression of the current macroblock with a threshold value.

6- Method according to claim 1 wherein, further to following the activation of the non-compressed mode, the state of the entropic coder is restored, that is to say the entropic coder returns to the previous state in which it was found at the start of the processing of the macroblock for which the non-compressed mode was triggered.

7- Video coding device implementing the method according to claim 1 and comprising at least:
a coding loop enabling the macroblocks to be compressed applying at least the steps of transform, quantization, intra prediction and motion compensation (64) to the incoming signal,
an entropic coder realizing in normal coding mode a compression of the data stream at the output of the coding loop and comprising the means to verify the efficiency of the compression, the means to decide on the use of the non-compressed mode, the means to configure the coding loop of the device and the means to verify the stability of said loop.
